(19) United States
(12) Patent Application Publication
(10) Pub. No.: US 2004/0071839 A1
(43) Pub. Date: Apr. 15, 2004

(54) Packaged cookie intermediates with integral designs

(76) Inventors: Susan M. Hayes-Jacobson, Minneapolis, MN (US); Julie A. Piasecki, Coon Rapids, MN (US); Glenn O. Rasmussen, Champlin, MN (US); Cara J. Sekerak, Lakeville, MN (US); Julia M. Schmelzer, St. Louis Park, MN (US)

Correspondence Address: GENERAL MILLS, P O Box 1113, Minneapolis, MN, 55440, US

(21) Appl. No.: 10/267,539

(22) Filed: Oct. 9, 2002

(51) Int. Cl. A23B 4/00

(52) U.S. Cl. 426/128

(57) ABSTRACT

The present invention relates to packaged, convenient to use cookie intermediates having an integral design element which can be provided on a commercially produced scale. The individual cookie dough intermediates can be produced having any sort of internally, predetermined design element and is provided in a convenient packaging arrangement. More specifically, the present invention is directed to the creation of individual predetermined dough intermediates that include an interior and integral arrangement of dough shapes, designs or elements in order to create a composite cookie dough intermediate that is illustrative of a particular theme or event, such as holidays, special occasions, sporting events and the like, that are provided in a ready to use, convenient format without requiring any additional slicing, breaking or similar action prior to baking or cooking.

### CROSS-REFERENCES TO RELATED APPLICATIONS

None.

### FIELD OF THE INVENTION

The present invention relates to packaged, convenient to use cookie intermediates having an integral design element which can be provided on a commercially produced scale. The individual cookie dough intermediates can be produced having any sort of internally, predetermined design element and is provided in a convenient packaging arrangement. More specifically, the present invention is directed to the creation of individual predetermined dough intermediates that include an interior and integral arrangement of dough shapes, designs or elements in order to create a composite cookie dough intermediate that is illustrative of a particular theme or event, such as holidays, special occasions, sporting events and the like, that are provided in a ready to use, convenient format without requiring any additional slicing, breaking or similar action prior to baking or cooking.

### BACKGROUND OF THE INVENTION

There are currently a number of commercial offerings for ready to bake refrigerated cookies. One such exemplary offering includes sheets of scored, grooved or perforated blocks of cookie dough such as those illustrated in U.S. Pat. Nos. 6,280,783, 6,284,295 and 6,312,743. The scored dough sheet is provided in a package that may consist of a plate and outer wrapping. In use the consumer removes the sheet of dough from the package and breaks off individual squares or pieces. The pieces or squares are then placed on a cookie sheet or other baking vessel and upon the application of heat the cookies are baked. While the foregoing product provides a level of convenience, there are a number of drawbacks associated with this particular product. Insufficient scoring can cause irregular pieces to break off, creating cookies that are different in size or have an irregular appearance from that of the rest of the cookies on the sheet or pan. The breaking of the cookie pieces can also cause crumbling of the product when the individual cookies are separated from the sheet leaving the preparer with a mess to have to clean up. Moreover, the breaking of the cookies from the block requires the user to contact the dough with more hand surface area, due to the increased pressure needed to break the block, thereby soiling one's hands, which if in a hurry can be an additional distraction to the consumer.

Another example of refrigerated cookie dough products is shown in U.S. Pat. No. 5,171,599 (commonly assigned) in which edible bits, such as candy pieces, are embedded in the cookie dough. Again, the dough is removed from its packaging and baked. In addition, the decorations, while adding a pleasing aesthetic appearance to the cookie are visible only on one side of the cookie. Such that, if the cookie becomes inverted, the viewer cannot witness the decorative elements.

U.S. Pat. No. 5,620,713 (commonly assigned) discloses an extrusion die that is useful in creating a generally round cookie having an internal design. The design is created through the use of a plural dough streams that are fed through a die and extruded into a dough log that is then packaged in a tube. In use, the consumer then unwraps the log and slices the log into individual cookies. While this product offers convenience, it suffers from some drawbacks. The user is required to unwrap the dough log from the package and then the unused portion of the log must be wrapped to protect from spoiling. In addition, the user is required to slice off individual cookies from the log, which can lead to odd shaped cookies or cookies of different thickness, resulting in uneven baking of the cookies. That is, some cookies may be overdone, those that are sliced to thinly and some underdone, those that are sliced to thick. In addition, when slicing individual cookies off of the log, the internal design can smear thereby defeating the purpose of putting a design internally of the log.

U.S. Pat. No. 3,228,356 discloses the use of three separate pastry streams to produce a cookie having a particular design appearing on one surface or on the face of the cookie. Initially, a stream of pastry dough is extruded and a second stream of dough is extruded “thence out of the tubular letters ahead of the chocolate stream [first stream].” The third stream is extruded into the areas around the lettering [second stream] to produce an “extruded product having the transverse configuration.” Thus, the '356 reference produces a cookie to which a design is applied on to a single surface of the cookie. That is, the design is not integral with the cookie in that the decoration comes out ahead of the base, providing a single sided decoration or a laminated arrangement or appearance. Thus, once the cookie is flipped over, one only sees the backside or solid chocolate side of the cookie, minimizing the value of applying a design to the cookie. Such laminated cookies can also appear to have a “fabricated” look to them, in that each layer of the cookies is visible rather than a homogenous structure or configuration, in which the design element is integrated into the cookie itself.

There are many varieties of decorated cookies can these products can be found at any bakery, retail food store and the like. These cookies are typically created from a single type of dough and then cookie cutters, having the particular desired configuration of the final shape, are then pressed into the dough to produce a cookie having that shape, the matrix around the shape is then stripped away and the cookie is then baked. These cookies may have decorative elements added to them such as frosting, candy sprinkles, food coloring and the like. Decorative cookies made in this fashion suffer from a number of drawbacks, in that they are made individually or in very small batches and can be very time consuming as well as expensive to produce. Laminations may also be prone to separation through handling or ineffective bonding.

Another problem with cookies prepared by the foregoing process is that the decoration is only visible on one side of the cookie. That is, the design does not permeate each of the cookie surfaces and deliberate positioning of the cookies or “facing” must be done in the display case or package to show the decoration to prospective customers. As such, if the cookie become inverted in the package, cookie jar, gift box or the like, the effort that went into creating the decoration is lost as the decoration is not visible to the consumer.

In a commercial environment, a cookie puck having a design only on one side, can become inverted due to transfers from various conveyors thereby hiding the design, when the cookie puck is flipped over, due to differential speeds of the conveyor belts or variations in height, thereby causing the entire package in which the inverted cookies appear to be rejected. Correction of the situation precipitates manual intervention to fix the problem and incur additional costs to correct the problem.

Another problem with such prior art cookies is that the candy sprinkles or frosting and decorations can fall off the cookie, thereby distorting the initial design being offered by the manufacturer or baker. This again diminishes the value of the offering in the eyes of the consumer leaving the retailer with cookies that may no longer be salable as well as a display case littered with the decorative particulate matter that must be cleaned and removed at each closing of the retail establishment.

In other situations where food coloring is used to decorate the particular article, the food coloring can bleed into unintended areas making the design difficult to visualize. In addition, if the cookies with the dye or coloring are handled shortly after the coloring has been applied, such as with packaging, the food coloring can come off on the packaging or transfer to other cookies within the package, making the product look spoiled or unpalatable.

Thus, what is needed therefore, is a convenient to use, packaged cookie dough intermediate that can be produced at production speeds. The individual cookie dough intermediates of the present invention have an integral design, formed through the use of multiple dough streams, that is visible from both sides of the dough intermediate and which does not suffer from the drawbacks enumerated above.

All publications, patents and patent applications referred to in this specification are incorporated herein by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one embodiment of the present invention, a package for a plurality of individual cookie dough intermediates is provided and includes a package having a generally planar element that has an area which is sized and configured to hold a number of cookie dough intermediates the package assembly also has an overwrap that has been sized and configured to contain the generally planar element with the cookie dough intermediates. A plurality of individual cookie dough intermediates is included and each of the individual cookie dough intermediates has a first and second face. The plurality of individual cookie dough intermediates are sized and configured to fit within the area of the generally planar element. At least one of the plurality of the individual cookie dough intermediates has an integral design element. The integral design element is visible on each of the first and second faces of the cookie dough intermediates. The integral design of the one of the plurality is visible on one of the first and second sides when the individual cookie dough intermediate is placed on the generally planar element.

A further embodiment of the present invention relates to an individual cookie dough intermediate having an integral design and provided in a convenient to use package. The cookie dough intermediate includes an area and at least a first and a second portion that cooperate to fill said area. The first portion of the cookie dough intermediate is provided in an amount ranging from 50 to 80% of the area of the individual cookie dough intermediate and the second portion of the cookie dough intermediate is provided in an amount ranging from 20 to 50% of the area of the individual cookie dough intermediate. The first portion has a first property and the second portion has a second property distinct from the first property, such that each of the first and second properties of the first and second portions is visible in a convenient to use package.

There are a number of permutations possible for each of the foregoing embodiments and one with skill in the art would readily recognize such variations.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 is a front view illustrating an integral design of one of the first and second faces of the individual cookie dough intermediate;

FIG. 1A is a cross sectional view of a cookie dough intermediate having an integral design illustrating that the design that is visible on each of the first and second sides of the individual cookie dough intermediate;

FIG. 2 is a front view of an alternate design appearing on one of the first and second faces of the individual cookie dough intermediate;

FIG. 3 is a front view of a further alternate design appearing on one of the first and second faces of the individual cookie dough intermediate;

FIG. 4 is a front view of the plurality of cookie dough intermediates in the generally planar tray of the package assembly;

FIG. 5 is a cut away view illustrating the outer packaging enclosing the tray of individual cookie dough intermediates;

FIG. 6 is a schematic of the apparatus for producing the individual cookie dough intermediates.

### DETAILED DESCRIPTION OF THE INVENTION

As used herein the term “dough intermediate”, “cookie dough intermediate” or “individual cookie dough intermediate” refers to an article that is produced or manufactured which is in an intermediate condition and requires some further processing such as baking, cooking or frying to change the intermediate into a condition that is suitable for consumption.

The term “plurality” as used herein means more than one. The term “majority” as used herein means 50.1% or more than half of the total.

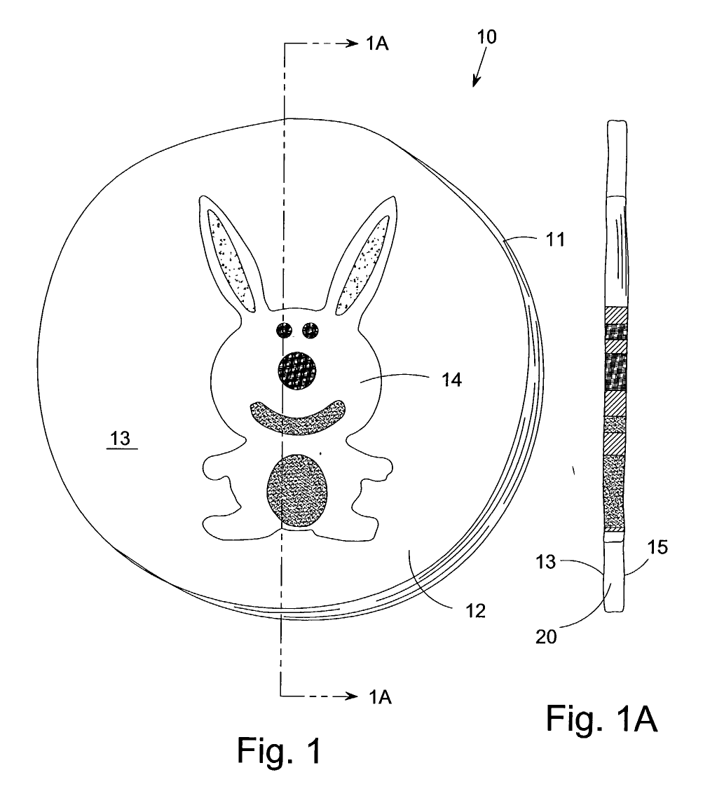

Turning now to FIG. 1, a cookie dough intermediate, having a generally circumferentially extending configuration is depicted by reference numeral 10. The cookie intermediate 10 has an external configuration 11, which is shown as circular, but may take other geometric configurations such as square, triangular, rectangular, hexagonal, pentagonal, and the like. The cookie dough intermediate is provided with first and second sides 13 and 15 (illustrated in FIG. 1A). The cookie dough intermediate 10 is provided with a first portion 12 that is provided in an amount of the dough intermediate of up to about 80% of the total amount of the cookie dough intermediate 10. Preferably, the first portion 12 is provided in an amount of the total intermediate ranging from 50 to 80% and more preferably from 50 to 70%. That is, the first portion 12, makes up at least a majority of the surface area of the intermediate 10.

A second portion 14 provides the integral design portion of the cookie dough intermediate 10 and is provided in an amount ranging from 1 to 60% and more preferably from 10 to 30% of the total of the dough intermediate 10. The design element is illustrated as being centrally disposed within the cookie dough intermediate 10. However, it is to be understood that the design 14 may appear anywhere within the cookie dough intermediate 10. Additional portions (not shown), may also be provided along with the first and second portions 12 and 14 of the dough intermediate 10. Where such additional portions are provided they are done so in an amount generally ranging from 1 to 40% (typically less than 40%) of the total of the dough intermediate 10 and more preferably in the amount of 2 to 10% of the shaped cookie dough intermediate

Where two dough portions are used, an exemplary ratio of the first to second portions (12 and 14) would range from 80:20 to 60:40 and more preferably about 66:34 (for a total of 100% of the amount or volume or surface area of the intermediate). If more than two dough streams are used to create separate portions of the intermediate 10, there are many permutations that can exist in configuring the ratio of dough portions to arrive at the particular aesthetic features of the integral design element and intermediate background or base.

The present invention also contemplates the use of more than two dough streams. Where three dough portions are used, an exemplary ratio of the first to second to third portions would include 60:30:10 (for a total of 100% of the amount or volume or surface area of the intermediate). Alternatively, four dough portions may be used abd the ratio of the dough portions to one another may include 50:20:20:10 (100% of the area or surface or volume of the intermediate). Obviously, there are many permutations that can exist in configuring the ratio of dough portions to arrive at the particular aesthetic features of the integral design element and intermediate background or base.

The first portion 12 is typically representative of the background portion of the cookie dough intermediate 10 of the present invention and will comprises generally more than one half of the total volume or area of the intermediate 10, that is a majority of the area or volume of the cookie intermediate. The design may be wholly confined within the background portion or may extend to or even beyond the edge 11 or be coterminous with the exterior edge 11 of the dough intermediate 10.

The second portion 14 and alternatively other portions will comprise generally less than half of the volume or area of the intermediate 10. In any event, the background portion or first portion 12 and the second portion 14, combine or cooperate with one another to facilitate the creation of the integral design and hence the recognition of the theme or event. Obviously, one would recognize that the larger portion may not have to be the background portion but could comprise another major area such as the body of an animal or the leafs and branches of a tree. In any event, the first portion 12 would make up the substantial portions or areas of the character, theme or design to be illustrated and such portions or areas may be cumulative in nature.

The first portion 12 of the dough intermediate 10 is provided with a first property. That property may include coloration, texture, (such as creating a crispy texture upon cooking or a chewier texture after baking) taste, (such as a higher or lower level of sweetness than the other portion 14 or additional portions of the intermediate, if provided) or even different flavors to accentuate the decoration of the cookie dough intermediate 10. For example, each of the portions of the dough, such as a first portion and a second portion 12 and 14, could each have a different flavor, one might be an orange flavor and the other might be cinnamon flavor.

Turning to FIG. 1A, a cross section 20 of the cookie dough intermediate 10 is provided. In FIG. 1A each of the dough portions 12 and 14 extend all the way through the cookie intermediate 10 such that each of the portions 12 and 14 of the design are visible on each side 13 and 15 of the exterior or faces of the cookie dough intermediate 10.

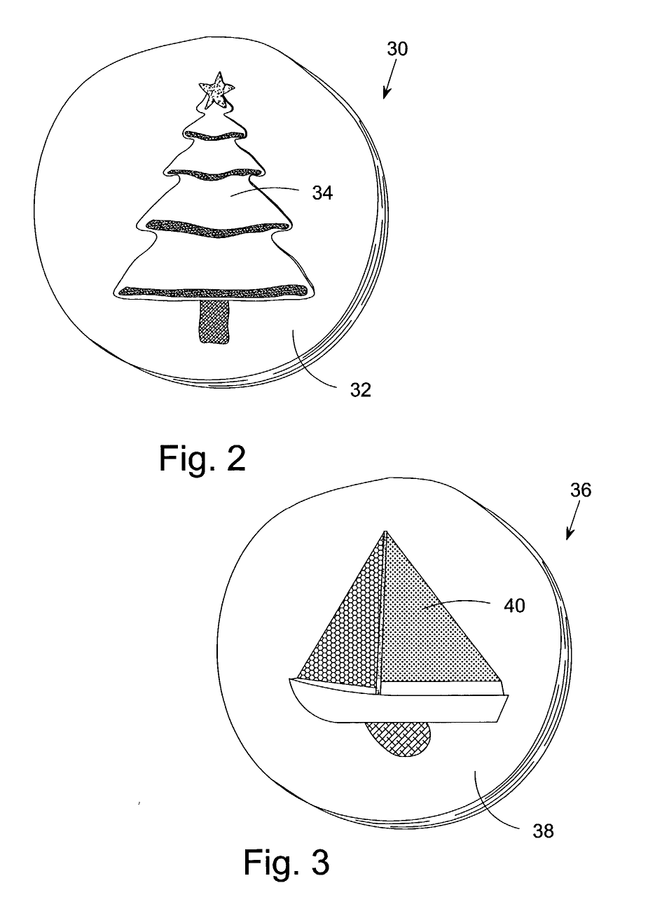

Reference numeral 30 in FIG. 2, generally depicts a cookie dough intermediate having a first portion 32 and a second portion 34. The portions have been provided to resemble an evergreen tree that may be reminiscent of certain holiday celebrations.

Reference numeral 36 in FIG. 3 depicts a cookie dough intermediate having a first portion 38 and a second portion 40. The portions have been provided as an illustration to resemble a sailboat. While the embodiments provided in FIGS. 2 and 3 are illustrative of alternative designs, it should be understood that any design could be produced in accordance with the present invention. That is, cookie dough intermediates could be produced having integral designs relating to sporting events, holiday occasions, seasonal recognitions, human and animal figures, inanimate symbols and the like.

It should be understood that all of the cookie dough intermediates 10 in a package may not have a design 14 and may be “faceless.” That is, the package can contain only a single cookie dough intermediate 10 having a design 14 or a majority of the intermediates may have a design 14 or less than a majority may have a design or all of the intermediates 10 may have a design 14.

In producing the cookie dough intermediates 10 of the present invention the dough formulations, and the ingredients they contain, can differ depending on the finished product the dough is to be used for. However, most doughs generally have a number of ingredients in common, examples of some such common ingredients are described and illustrated in more detail below.

The dough of the invention generally contains a grain constituent that contributes to the structure of the dough. Different grain constituents lend different texture, taste and appearance to a baked good. Flour is the most commonly used grain constituent in baked goods, and in most baked foods is the primary ingredient.

Suitable flours include hard wheat flour, soft wheat flour, corn flour, high amylose flour, low amylose flour, and the like. For example, a dough product made with a hard wheat flour will have a more coarse texture than a dough made with a soft wheat flour due to the presence of a higher amount of gluten in hard wheat flour.

The doughs of the invention also generally include leavening agents that increase the volume and alter the texture of the final baked good. Such leavening agents can either be chemical leavening agents or yeast.

Chemical leavening typically involves the interaction of at least one leavening acid and at least one leavening base. The leavening acid generally triggers the release of carbon dioxide from the leavening base upon contact with moisture. The carbon dioxide gas aerates the dough or batter during mixing and baking to provide a light, porous cell structure, fine grain, and a texture with a desirable appearance and palatability.

Sodium bicarbonate, or baking soda, a leavening base, is the primary source of carbon dioxide gas in many chemical-leavening systems. This compound is stable and relatively inexpensive to produce. Other leavening bases include for example potassium bicarbonate, ammonium carbonate and ammonium bicarbonate.

Leavening bases can be modified in order to alter the way in which they work. For example, they can be encapsulated. Encapsulated leavening bases, such as encapsulated baking soda, will tend to delay the onset of the leavening reaction because the encapsulating material must dissolve before the leavening reaction can occur.

Generally, the invention can utilize modified or non-modified leavening bases as part of a chemical leavening system. Specifically, however, one embodiment of the invention utilizes non-encapsulated leavening bases as part of the chemical leavening system.

Leavening acids include sodium or calcium salts of ortho, pyro, and complex phosphoric acids in which at least two active hydrogen ions are attached to the molecule. Baking acids include compounds such as monocalcium phosphate monohydrate (MCP), monocalcium phosphate anhydrous (AMCP), sodium acid pyrophosphate (SAPP), sodium aluminum phosphate (SALP), dicalcium phosphate dehydrate (DPD), dicalcium phosphate (DCP), sodium aluminum sulfate (SAS), glucono-delta-lactone (GDL), and potassium hydrogen tartrate (cream of tartar).

The dough of the invention can also contain additional ingredients. Some such additional ingredients can be used to modify the texture of dough. Texture modifying agents can improve many properties of the dough, such as viscoelastic properties, plasticity, or dough development. Examples of texture modifying agents include fats, emulsifiers, hydrocolloids, and the like.

Shortening helps to improve the volume, grain and texture of the final product. Shortening also has a tenderizing effect and improves overall palatability and flavor of a baked good. Natural shortenings, animal or vegetable, or synthetic shortenings can be used. Generally, shortening is comprised of triglycerides, fats and fatty oils made predominantly of triesters of glycerol with fatty acids. Fats and fatty oils useful in producing shortening include cotton seed oil, ground nut oil, soybean oil, sunflower oil, rapeseed oil, sesame oil, olive oil, corn oil, safflower oil, palm oil, palm kernel oil, coconut oil, or combinations thereof.

Emulsifiers include nonionic, anionic, and/or cationic surfactants that can be used to influence the texture and homogeneity of a dough mixture, increase dough stability, improve eating quality, and prolong palatability. Emulsifiers include compounds such as lecithin, mono- and diglycerides of fatty acids, propylene glycol mono- and diesters of fatty acids, glyceryl-lacto esters of fatty acids, and ethoxylated mono- and diglycerides.

Hydrocolloids are added to dough formulations to increase moisture content, and to improve viscoelastic properties of the dough and the crumb texture of the final product. Hydrocolloids function both by stabilizing small air cells within the batter and by binding to moisture within the dough. Hydrocolloids include compounds such as xanthan gum, guar gum, and locust bean gum.

Dough can also include flavorings such as sweeteners, spices, and specific flavorings such as bread or butter flavoring. Sweeteners include regular and high fructose corn syrup, sucrose (cane or beet sugar), and dextrose, for example. In addition to flavoring the baked good, sweeteners such as sugar can increase the moisture retention of a baked good, thereby increasing its tenderness.

Dough can also include preservatives and mold inhibitors such as sodium salts of propionic or sorbic acids, sodium diacetate, vinegar, monocalcium phosphate, lactic acid and mixtures thereof.

The consistency of the dough must be monitored in that if the dough is too sticky, processing difficulties arise. If the dough is too dry, then issues related to consumer satisfaction, e.g. taste, texture, are created. In one embodiment of the present invention, the amount of sugar is increased from a conventional dough product and the amount of flour is decreased. This creates a dough that is typically more sticky, due to the presence of the additional sugar, and also one that is more desirable from a satisfaction standpoint. In light of the more sticky nature of the dough, additional care must be taken in processing to avoid equipment slow down or even down time for the entire processing line.

If the proper consistency for the shaped cookie dough intermediate is not achieved, the dough will spread out and the desired shape of the dough intermediate will be reduced or even lost, thereby mitigating the aesthetic appearance and value of the intermediate.

The present invention is now illustrated in greater detail by way of the following examples, but it should be understood that the present invention is not to be construed as being limited thereto.

In preparing the preferred dough for use as an intermediate in the present invention the following formulation was used.

| Ingredient | Weight Percent |
|---|---|
| Sugar | 30.91 |
| Shortening | 24.6 |
| Water | 7.03 |
| Vanilla | .27 |
| Salt | .54 |
| Flour | 34.34 |
| Albumin | .5 |
| WES | 1 |
| Soda | .4 |
| SALP | .42 |
| Total | 100 |

All percentages and ratios are calculated by weight unless otherwise indicated. All percentages and ratios are calculated based on the total composition unless otherwise stated.

In preparing the dough intermediates of the present invention, two batches of dough are created to produce first and second portions, 12 and 14, which may have first and second properties. While in the present embodiment, on two dough streams are provided it is to be understood that more than two streams of dough can be used in creating designs in the cookie dough intermediate.

The dough is mixed in accordance with the above-mentioned formula and is prepared in a conventional manner, such as by first blending the sugar and shortening together to create sort of a thick “cream” and then adding a wet of ingredients (water, vanilla, salt) to the “cream” mixture. This combination is then mixed with flour to produce the dough. The dough used in the present invention should have a density ranging from 0.8 to 1.2 and more preferably from 1 to 1.1. In addition, the pH of the dough is preferably around 8, or near the pH of the large portion of the ingredients (flour, sugar).

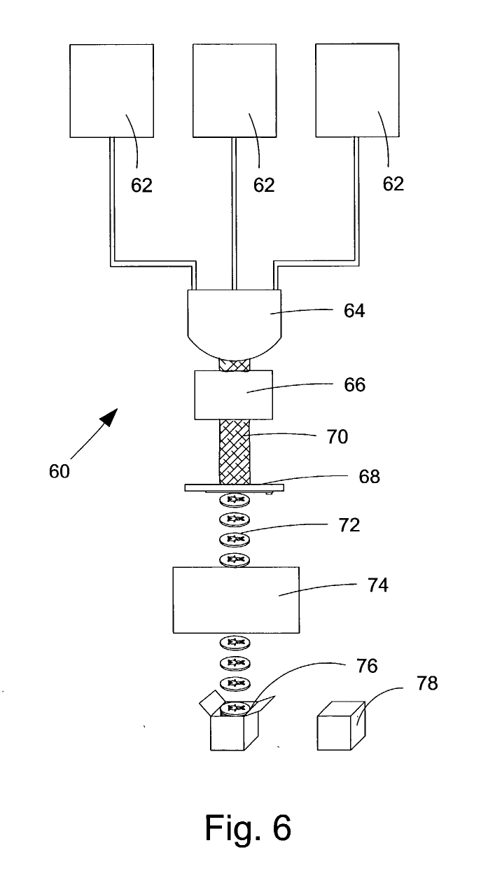

Once the dough is formed each of the dough batches (individual batches may contain different colors or properties such as a dough that will be crispy or chewy after baking) are placed within hoppers designated by numeral 62 and as illustrated in FIG. 6. The schematic drawing provides a series of three hoppers 62 for illustration purposes only. In the present embodiment, only two hoppers are used. The dough is fed from the hoppers 62 into an extruder 64 such as a Bepex extruder available from Bepex GmBh of Leingarten, Germany. The extruder 64 combines the multiple dough streams into a rope or tube 70 and the rope 70 is then cooled by the rope precooler 66. The extrusion temperature of the dough is approximately 40 to 70° F. and more preferably from 50 to 70° F. Extrusion is performed at a speed of greater than ten feet per minute.

After extrusion, the rope 70 may be cooled by a precooler 66 and the cooling can be accomplished by a number of methods such as by an air blast, holding the dough in a chamber at a reduced temperature or by other means. In the present invention, an air blast is used and the dough rope is cooled to between 40 and 65° F. and more preferably to between 40 and 55° F. The cooling is done over roughly a thirty second to two minute interval. However, it should be understood that pre-cooling of the rope 70 may not be necessary depending upon the temperature of the dough as it exits the extruder 64.

Next, the dough rope 70, regardless of whether it traverses a cooling station, travels to a cutting station 68 where the dough rope 70 is sliced in to individual cookie dough intermediates or “pucks.” There are many cutting devices that can be used and these include mechanical or reciprocating knifes and blades, saw and even ultrasonic cutters can be used. The cutting device should operate at a sufficient speed so as to eliminate smearing of the integral design and enable the dough rope 70 to be cleanly sliced into individual pucks or cookie pieces. The cutting is performed at greater than 60 cuts per minute and preferably greater than 2,000 cuts per minute. Cutting speed can vary depending on the temperature of the dough rope. The individual pucks are cut to a width ranging from ¼″ to 1″ and more preferably from ⅜″ to about 1″.

From the cutter 68, (still referring to FIG. 6) the individual cookie pucks 72 are moved away from the cutter 68 through the use of a moving conveyor belt (not shown) that travels at roughly greater than 20 feet per minute. The difference in speed between the conveyor belt and the extruder 70 enables the individual pucks 72 to be separated from one another as they move toward the next station and away from the extruder. Next, the pucks 72 are moved through a tunnel freezer 74 where the cookie dough intermediates 72 are cooled and frozen. As the cookie dough intermediates 72 are now of a single thickness (that of the width of the cookie) cooling of the dough occurs more quickly than when the dough is in a rope or tube 70 if cooling of the rope is required. After freezing the cookie intermediates are packaged shown by reference numerals 76 and 78.

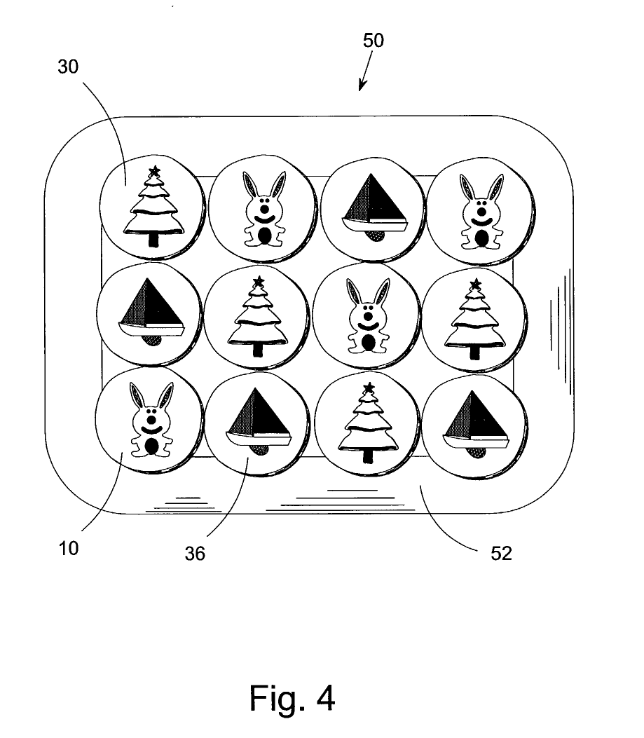

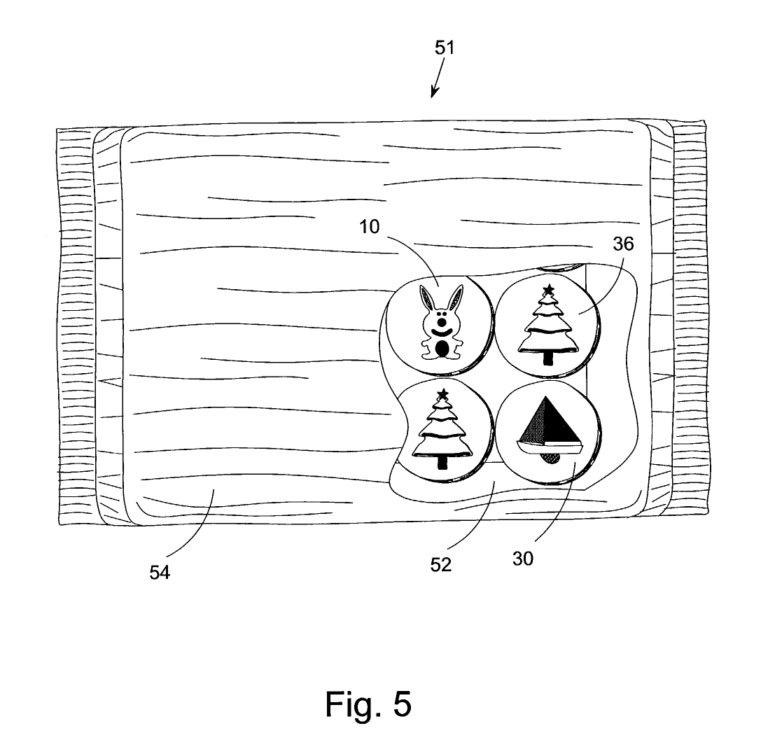

Reference is now directed to FIGS. 4 and 5 which relate to the package for the cookie dough intermediates. Once the cookie dough intermediates 10 have been frozen, the intermediates are placed in trays as shown in FIG. 4, wrapped in protective films, illustrated in FIG. 5 and placed in cartons for shipping and storage. Each tray can preferably have between 12 and 24 pucks or cookie dough intermediates but other permutations are possible. For example, cookie dough intermediates could be provided in groups of five, such as five, ten, fifteen, twenty, etc. or in other amounts such as those that are divisible by two or three.

FIG. 4 is illustrative of the arrangement 50 under which the cookie dough intermediates 10, 30 and 36 are packed. The cookie dough intermediates 10, 30 and 36 are placed on a generally planar tray 52 which may or may not have slightly inclined sidewalls to prevent the cookie dough intermediates from splaying out of arrangement. As illustrated in FIG. 4, the arrangement depicted 50 shows several design of cookie dough intermediates on the tray 52. It should be understood, that there may be multiple designs, only a single design or even some “faceless” cookies (cookies without an integral design) combined with other cookies having a design. In any event, the present invention contemplates a tray 52 having at least one cookie with an integral design, which for example could be used in a game or sweepstakes where the purchaser would search for the cookie with an integral design in the package.

FIG. 5 is an illustration of tray enclosed within an overwrap packaging 51. The overwrap may comprise plastics and/or films, such as polyethylene derived films and plastic, coated and synthetic papers or other suitable, generally air impermeable materials. As shown in FIG. 5, a portion of the film 54 has been removed so that the cookie dough intermediates 10, 30 and 36 having an integral design are visible.

In addition to the trays or boxes of cookie dough intermediates, the trays may be provided with supplemental items such as a decorating kit, candy sprinkles, frosting tubes and the like so that the consumer may add additional decoration to the cookies after the intermediate has been baked.

It will thus be seen according to the present invention a highly advantageous cookie dough intermediate having a integral, preformed extruded design has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A package for a plurality of individual cookie dough intermediates comprising;
a package having a generally planar element having an area, said generally planar area is sized and configured to hold a number of cookie dough intermediates and said package further including an overwrap that is sized and configured to contain said generally planar element;
a plurality of individual cookie dough intermediates, each of said individual cookie dough intermediates having a first and second face, said plurality of individual cookie dough intermediates sized and configured to fit within said area of said generally planar element;
at least one of said plurality of said individual cookie dough intermediates having an integral design element, said integral design element being visible on each of said first and second faces of said cookie dough intermediates; and
wherein said integral design of said one of said plurality is visible on one of said first and second sides when said individual cookie dough intermediate is placed on said generally planar element.

2. A package for a plurality of individual cookie dough intermediates as recited in claim 1, wherein a majority of said plurality of said individual cookie dough intermediates includes said integral design.

3. A package for a plurality of individual cookie dough intermediates as recited in claim 1, wherein all of said plurality of said individual cookie dough intermediates includes said integral design.

4. A package for a plurality of individual cookie dough intermediates as recited in claim 1, wherein said integral design is an animate shape.

5. A package for a plurality of individual cookie dough intermediates as recited in claim 1, wherein said integral design is a geometric shape.

6. A package for a plurality of individual cookie dough intermediates as recited in claim 1, wherein said integral design is an inanimate shape.

7. A package for a plurality of individual cookie dough intermediates as recited in claim 1, wherein said integral design and said individual cookie dough intermediates are formed from first and second dough streams.

8. A package for a plurality of individual cookie dough intermediates as recited in claim 7, wherein said first and second dough streams have first and second properties distinct from one another.

9. A package for a plurality of individual cookie dough intermediates as recited in claim 8, wherein said first and second properties are different colors.

10. A package for a plurality of individual cookie dough intermediates as recited in claim 8, wherein said first and second properties are different textures.

11. A package for a plurality of individual cookie dough intermediates as recited in claim 1, wherein said plurality of cookie dough intermediates provided in said package is divisible by two.

12. A package for a plurality of individual cookie dough intermediates as recited in claim 1, wherein said plurality of cookie dough intermediates provided in said package is divisible by three.

13. A package for a plurality of individual cookie dough intermediates as recited in claim 1, wherein said plurality of cookie dough intermediates provided in said package is divisible by five.

14. A package for a plurality of individual cookie dough intermediates as recited in claim 1, wherein said cookie dough intermediates having a width ranging from ¼″ to 1″.

15. An individual cookie dough intermediate having an integral design and provided in a convenient to use package, comprising;
a cookie dough intermediate having an area and at least a first and a second portion, said at least first and second portions cooperating to fill said area;
said first portion of said cookie dough intermediate is provided in an amount ranging from 50 to 80% of said area of said individual cookie dough intermediate;
said second portion of said cookie dough intermediate is provided in an amount ranging from 20 to 50% of said area of said individual cookie dough intermediate; and
wherein said first portion has a first property and said second portion has a second property distinct from said first property, such that each of said first and second properties of said first and second portions is visible in a convenient to use package.

16. An individual cookie dough intermediate having an integral design and provided in a convenient to use package as recited in claim 15, wherein said cookie dough intermediate has a width ranging from ¼″ to 1″.

17. An individual cookie dough intermediate having an integral design and provided in a convenient to use package as recited in claim 15, wherein said first portion is a background portion of said cookie dough intermediate.

18. An individual cookie dough intermediate having an integral design and provided in a convenient to use package as recited in claim 15, wherein said second portion is an integral design contained within said cookie dough intermediate.

19. An individual cookie dough intermediate having an integral design and provided in a convenient to use package as recited in claim 18, wherein said integral design is an animate shape.

20. An individual cookie dough intermediate having an integral design and provided in a convenient to use package as recited in claim 18, wherein said integral design is an inanimate shape.

21. An individual cookie dough intermediate having an integral design and provided in a convenient to use package as recited in claim 15, wherein said first and second properties are different colors.

22. An individual cookie dough intermediate having an integral design and provided in a convenient to use package as recited in claim 15, wherein said first and second properties are doughs that produce different textures.

23. An individual cookie dough intermediate having an integral design and provided in a convenient to use package as recited in claim 15, wherein said cookie dough intermediate includes a third portion.

24. An individual cookie dough intermediate having an integral design and provided in a convenient to use package as recited in claim 23, wherein said cookie dough intermediate includes a fourth portion.
